(19) United States
(12) Patent Application Publication
(10) Pub. No.: US 2013/0327233 A1
(43) Pub. Date: Dec. 12, 2013

(54) VOLUME REDUCTION DEVICE

(71) Applicant: John Cross, Burleigh Waters (AU)

(72) Inventor: John Cross, Burleigh Waters (AU)

(73) Assignee: RECYCLING SOLUTIONS PTY LTD, Burleigh Waters, QLD (AU)

(21) Appl. No.: 13/976,922

(22) PCT Filed: Dec. 7, 2011
(86) PCT No.: PCT/AU2011/001584

§ 371 Date: Jun. 27, 2013

(30) Foreign Application Priority Data
Dec. 8, 2010 (AU) 201010388

(51) Int. Cl. B30B 1/02

(52) U.S. Cl. CPC B30B 1/02
USPC 100/245

(57) ABSTRACT

A device for reducing the volume of empty cans and bottles comprises a housing having one open side to receive a can or bottle, two retaining plates and a slot extending centrally and substantially the length of two opposing sides of the housing, two pins extending through a box shaped ram and through both slots in the sides of the housing, and a lever having two arms each connected to an end of one of the pins by a linkage wherein moving the lever results in sliding movement of the ram along the slots. By moving the lever, a can or bottle placed within the housing will be crushed between one plate and the ram to significantly reduce its volume.

### FIELD OF THE INVENTION

This invention relates to devices for reducing the volume of empty containers.

### BACKGROUND OF THE INVENTION

Plastic bottles and aluminium or steel cans are commonly used to package foods and beverages. These materials can be recycled to produce other products which both reduces the use of natural resources and requires less energy and costs less than producing products from raw materials. Recycling these products also prevents them from entering landfill where they take many years to break down and put a burden on the environment.

Society is becoming increasingly aware of environmental sustainability measures such as recycling and accordingly, the tendency to recycle everyday packaging, such as bottles and cans, is on the rise.

However, these containers have a large empty volume and take up significant space in bins, waste transport vehicles, landfill sites and recycling storage containers. Both domestic and commercial recycling bins quickly fill up and consequently not all bottles and cans are being recycled.

Reducing the volume of empty containers greatly increases how many items can be stored in recycling bins and the like. DE202006007515 (U1) discloses a hand operated press assembly for crushing plastic bottles having a housing to receive a bottle and a pressure plate which is pressed towards a fixed wall of the housing by a lever. However, the lever assembly of this device cannot create sufficient pressure to crush aluminium or steel cans and the pressure plate tends to twist and buckle under the torque created by the lever.

### OBJECT OF THE INVENTION

It is therefore an object of the present invention to provide an improved device for reducing the volume of cans and bottles or at least to provide an alternative to the prior art.

### STATEMENT OF THE INVENTION

According to the present invention a device for reducing the volume of empty containers comprises a housing having one open side to receive a container, two retaining plates and a slot extending centrally and substantially the length of two opposing sides of the housing, two pins extending through a box shaped ram and through both slots in the sides of the housing, and a lever having two arms each connected to an end of one of the pins by a linkage wherein moving the lever results in sliding movement of the ram along the slots. Preferably the lever is pivoted at one end of the housing by a rod which passes through the housing.

Preferably at least one of the retaining plates has at least one safety tab extending therefrom whereby the lever can be pressed past the tab to secure it.

Preferably at least one of the plates has a hole to receive the neck of a bottle.

In one embodiment a safety shield encases the device to enclose the workings of the device and prevent physical injury.

Preferably, moving the lever results in sliding movement of the ram along the slots in the same direction as the lever.

### BRIEF DESCRIPTION OF THE DRAWINGS

An embodiment of the invention is now described by way of example only with reference to the accompanying drawings in which:

FIG. 1 is an exploded view of the volume reduction device of the present invention.

FIG. 2 is an isometric view of the volume reduction device of the present invention in its open configuration.

FIG. 3 is an isometric view of the volume reduction device of the present invention in its closed configuration.

### DETAILED DESCRIPTION OF THE INVENTION

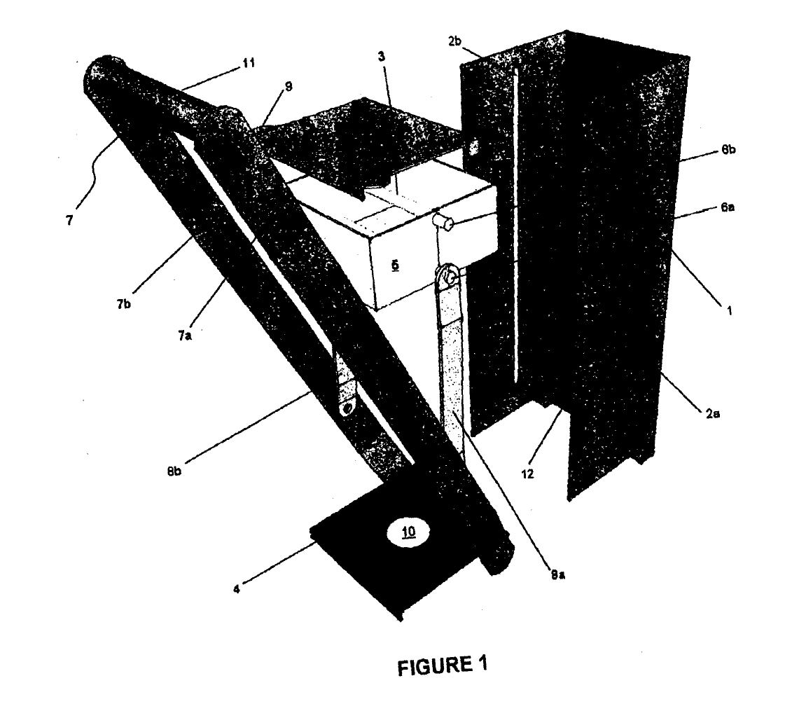

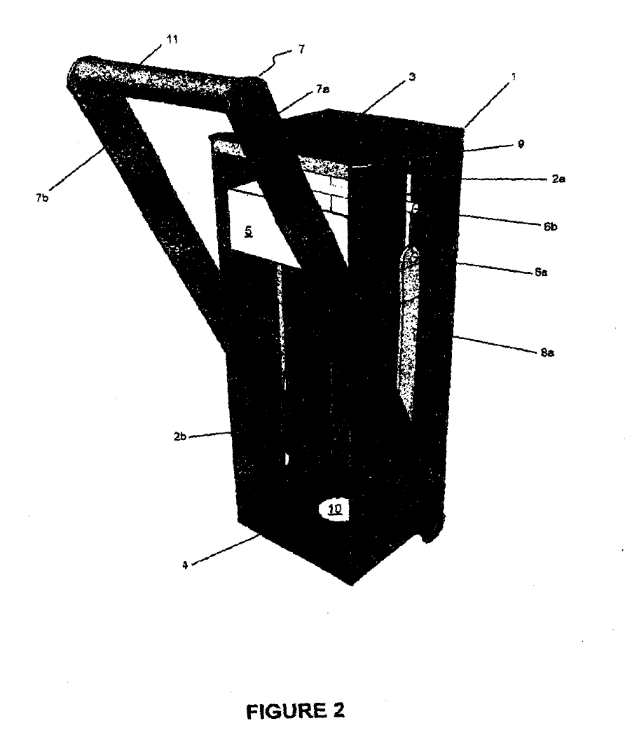

As shown in FIGS. 1 and 2, a device for reducing the volume of empty containers, such as cans and bottles, comprises rectangular housing 1 having one open side to receive a can or bottle. Slot 2a and 2b extend centrally and substantially the length of two opposing sides of the housing. Slots 2a and 2b are of the same length and location within each side. Two retaining plates 3 and 4 are fixed to the top and bottom of housing 1.

Box shaped ram 5 is located within housing 1 by two pins 6a and 6b. Pins 6a and 6b extend through box shaped ram 5 and through slots 2a and 2b in either side of housing 1. The diameter of pins 6a and 6b is slightly less than the width of slots 2a and 2b to allow slidable movement of pins 6a and 6b within slots 2a and 2b while preventing transverse twisting of the pins. Pins 6a and 6b extend a short distance outside housing 1 to allow the addition of a nut or the like on each end to secure pins 6a and 6b and ram 5 within the slots. Pins 6a and 6b are located some distance apart to stabilise the ram and prevent it from tilting or bowing during use. Ram 5 is constructed of thick steel and the lower surface of ram 5 is flat in order to crush a bottle or can.

Lever 7 having two arms 7a and 7b Is pivoted at one end by rod 12 which passes through housing 1. The opposite end of lever arms 7a and 7b are joined by handle 11.

Lever arms 7a and 7b are connected to the lower of the pins 6a by linkages 8a and 8b such that moving lever 7 results in ram 5 sliding along slots 2a and 2b in the same direction as lever 7. Linkages 8a and 8b operate in tension, pulling the ram 5 onto the container to crush the container. By operating in tension, linkages 8a and 8b are less likely to buckle, twist or fail during use.

In the open position, as shown in FIG. 2, ram 5 is at the top of housing 1 and lever 7 is extending upwardly. A can or bottle is placed within housing 1 resting on bottom plate 4 and underneath ram 5. Lever 7 can then be pulled downwardly causing linkages 8a and 8b to pull downwardly on pin 6a and subsequently causing ram 5 to be pulled downwardly towards the bottle or can.

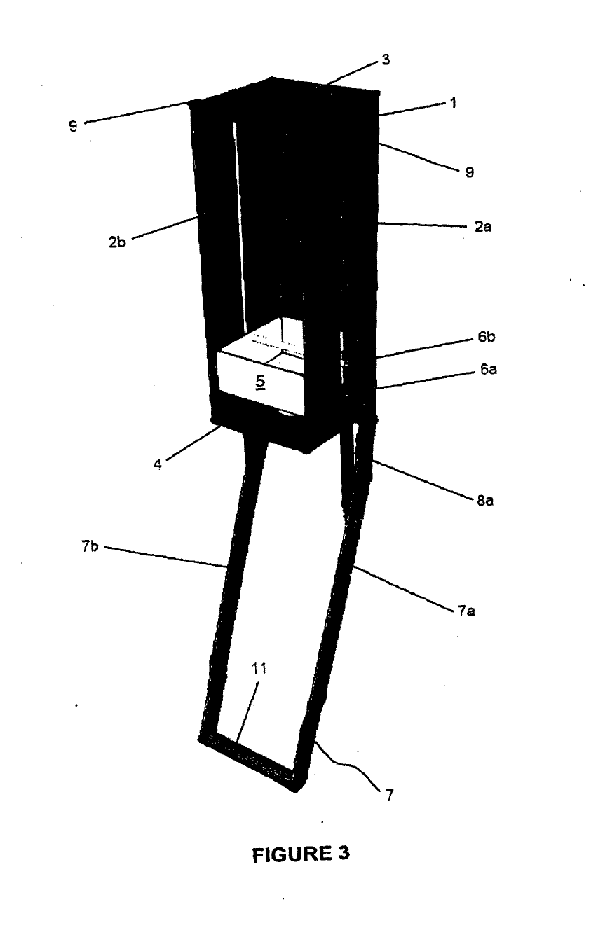

The torque created by pulling lever 7 is equivalent to approximately 150 kilograms of force which is sufficient to crush aluminium and steel cans and large plastic bottles between ram 5 and bottom plate 4. In the closed position, shown in FIG. 3, the lower surface of ram 5 is close to bottom plate 4 and the bottle or can is crushed there between. Lever 7 is extending downwardly away from housing 1.

Top plate 3 has two locking tabs 9 which protrude from each side of plate 3. Lever 7 can be pressed past tabs 9, such that each arm 7a and 7b is located behind a tab 9, to secure it in the upright position and to prevent it from accidentally falling onto a user and causing injury. Lever 7 can be released by pulling it past locking tabs 9. Bottom plate 4 has a centrally located hole 10 which can receive a bottle neck to hold the bottle in place during crushing.

In public areas or even in households with small children, housing 1 can be encased in a safety shield (not illustrated). The safety shield wraps around the device to enclose the workings of the device and prevent fingers being caught in slots 2a and 2b or linkages 8a and 8b or other physical injuries. Housing 1 can be secured to a wall or post and can be used in an upright position. The person skilled in the art would recognise that the relative terms such as top and bottom plates, downward and upward used throughout the description are based on this preferred position. However, the device can of course be mounted in a horizontal or any other position and the person skilled in the art would appreciate that interpretation of these terms should vary accordingly.

### ADVANTAGES

The volume reduction device of the present invention uses two pins to guide and stabilise the box shaped ram which prevents tilting during use and focuses the force onto the bottle or can. The present invention can crush aluminium and steel cans to around 4 millimetres thick. Plastic bottles can be crushed to a similar thickness however given the natural elasticity of plastic, the bottles will expand slightly when released from the device. Nonetheless the volume of the cans and bottles is significantly reduced allowing greater storage capacity in bins and the like. This means that recycling bins need not be emptied so frequently saving on waste collection expenses and each household or commercial establishment can more effectively recycle waste products.

### VARIATIONS

It will be realized that the foregoing has been given by way of illustrative example only and that all other modifications and variations as would be apparent to persons skilled in the art are deemed to fall within the broad scope and ambit of the invention as herein set forth.

Throughout the description and claims of this specification the words “comprise” and variations of that word such as “comprises” and “comprising” are not intended to exclude other additives components integers or steps.

1. A device for reducing the volume of empty containers comprising:
a housing having one open side to receive a container, two retaining plates and a slot extending centrally and substantially the length of two opposing sides of the housing;
two pins extending through a box shaped ram and through both slots in the sides of the housing; and
a lever having two arms each connected to an end of one of the pins by a linkage wherein moving the lever results in sliding movement of the ram along the slots to crush the container.

2. The device of claim 1 wherein the lever is pivoted at one end of the housing by a rod which passes through the housing.

3. The device of claim 1 wherein at least one of the retaining plates has at least one safety tab extending therefrom whereby the lever can be pressed past the tab to secure it.

4. The device of claim 1 wherein at least one of the plates has a hole to receive the neck of a bottle.

5. The device of claim 1 further comprising a safety shield which encases the device to enclose the workings of the device and prevent physical injury.

6. The device of claim 1 wherein moving the lever results in sliding movement of the ram along the slots in the same direction as the lever.

7. The device of claim 1 wherein the linkage operates in tension between the lever and the pin to move the ram.

8. The device of claim 2 wherein at least one of the retaining plates has at least one safety tab extending therefrom whereby the lever can be pressed past the tab to secure it.

9. The device of claim 8 wherein at least one of the plates has a hole to receive the neck of a bottle.

10. The device of claim 3 wherein at least one of the plates has a hole to receive the neck of a bottle.

11. The device of claim 2 wherein at least one of the plates has a hole to receive the neck of a bottle.

12. The device of claim 11 further comprising a safety shield which encases the device to enclose the workings of the device and prevent physical injury.

13. The device of claim 10 further comprising a safety shield which encases the device to enclose the workings of the device and prevent physical injury.

14. The device of claim 9 further comprising a safety shield which encases the device to enclose the workings of the device and prevent physical injury.

15. The device of claim 8 further comprising a safety shield which encases the device to enclose the workings of the device and prevent physical injury.

15. The device of claim 4 further comprising a safety shield which encases the device to enclose the workings of the device and prevent physical injury.

16. The device of claim 3 further comprising a safety shield which encases the device to enclose the workings of the device and prevent physical injury.

17. The device of claim 2 further comprising a safety shield which encases the device to enclose the workings of the device and prevent physical injury.

18. The device of claim 5 wherein moving the lever results in sliding movement of the ram along the slots in the same direction as the lever.

19. The device of claim 4 wherein moving the lever results in sliding movement of the ram along the slots in the same direction as the lever.

20. The device of claim 3 wherein moving the lever results in sliding movement of the ram along the slots in the same direction as the lever.
